(19) United States
(12) Patent Application Publication
(10) Pub. No.: US 2026/0339039 A1
(43) Pub. Date: Oct. 29, 2026

(54) FIBER OPTIC CONNECTOR

(71) Applicant: HUBER+SUHNER AG, CH-9100 HERISAU (CH)

(72) Inventors: Lothar Michael VÖLKER, Sax (CH); Hanns WATRINET, Eschenbach (CH)

(73) Assignee: HUBER+SUHNER AG, CH-9100 HERISAU (CH)

(21) Appl. No.: 18/997,406

(22) PCT Filed: Jul. 12, 2023
(86) PCT No.: PCT/EP2023/069255

§ 371 Date: Jan. 21, 2025

(30) Foreign Application Priority Data
Jul. 22, 2022 (CH) CH000888/2022

(51) Int. Cl. G02B 6/38

(52) U.S. Cl. CPC G02B 6/3823; G02B 6/3821; G02B 6/387; G02B 6/3885; G02B 6/38875; G02B 6/3893

(57) ABSTRACT

The present disclosure relates to a fiber optic connector (1) comprising, a tubular rear base element (5) which extends in a longitudinal direction (x) from a rear end (4) to a front end (5) and comprises on the inside a fiber deflection section (6) configured to provide deflection room for at least one laterally deflected optical fiber (8) extending in a mounted position of the fiber optic connector (1) across the tubular rear base element (5), tubular front base element (9) which comprises at its rear end (10) a recess (12) in which a front section (13) of the tubular rear base element (5) is arranged in a form fit manner and a ferrule (14) arranged deflectable against the force of a spring (15) in a ferrule holder (16) arranged inside of the tubular front base element (9) in front of the tubular rear base element (5).

### BACKGROUND OF THE INVENTION

### Field of the Invention

The present disclosure relates to a fiber optic connector with an improved multipart design, applicable for extensive cable lengths.

### Discussion of Related Art

EP 2142951 A1, published on 13 Jan. 2010, by the applicant relates to an optical connector, in particular for outside use, for detachably connecting at least two optical cables along a connector axis. The optical connector comprises a socket portion and a plug portion, which portions are substantially of cylindrical design with respect to the connector axis, can be detachably plugged into one another along the connector axis and can be locked in the plugged-in state. A locking mechanism, which is equipped with a latch function and which latches automatically during insertion is provided for the purposes of rapid locking.

US 2012257859 A1, published on 11 Oct. 2012, by Nhep Ponharith relates to a connector, which includes a ferrule assembly having a ferrule, a hub and a spring. The ferrule has a distal face accessible at a distal end of the connector housing, with the ferrule being movable in a proximal direction relative to the connector housing. The distal and proximal positions are separated by an axial displacement distance. The ferrule proximal movement is against the spring's bias. The cable of the assembly includes an optical fiber contained within a jacket and also a strength layer between the fiber and the jacket that is anchored to the connector housing. The fiber extends through a fiber passage from the proximal end of the connector housing to the ferrule. The fiber has a distal portion potted within the ferrule. The fiber passage has a fiber take-up region configured to take-up an excess length of the fiber corresponding to the ferrule axial displacement.

### SUMMARY OF THE INVENTION

When e.g. an optical cable assembly is coiled/uncoiled, the cable's inner components like the at least one optical fiber and the encompassing tube (so called empty tube), in which the at least on optical fibers is arranged, may be displaced relative to the ends of the optical cable in an unwanted manner. The same may apply when the cable is subject of axial load. This may cause problems as the at least one optical fiber and tube may be pushed into the fiber optic connector or pulled out of it in an unwanted manner. When being pushed into the fiber optic connector, buckling, kinking, or even fiber breakage may occur. Vice versa, when tension is applied to the optical cable, the at least one optical fiber may be pulled out of the fiber optic connector. As a result, the ferrule is pulled back and contact to a mating ferrule may be lost. In severe cases, the at least one optical fiber can be damaged by the excessive tension.

To avoid unwanted movement of the at least one optical fiber with respect to a thereto attached fiber optic connector, the inner cable components and the cable jacket are usually firmly bonded together with a low viscous adhesive which penetrates the strain relieve element (glass roving or aramid) forming part of the optical cable. One problem of such an arrangement is that the fiber over length-either too short or too long-within the fiber optic connector, e.g. caused by manufacturing tolerances of ferrule length, fiber length or the connector housing components, etc. cannot be controlled or compensated easily. Especially inappropriate fiber over length may result in fiber kinking when the fiber optic connectors are coupled or pulling on the fibers when the fiber optic connectors are released, hence causes signal loss or even fiber breakage.

One of the problems to be addressed can be seen in providing an assembly friendly fiber optic connector, allowing an adjustment of the fiber over length within the fiber optic connector during assembly.

A fiber optic connector according to the disclosure and as described hereinafter offers the possibility to overcome this problem. The fiber optic connector offers the possibility to efficiently adjust to different fiber lengths in the fiber optic connector during the assembly process. In addition, given the small dimensions and short fiber lengths, it is desired that the fiber optic connector is designed in a manner, such that an efficient assembly process can be achieved. A fiber optic connector according to the disclosure therefore typically comprises a tubular base element extending in a longitudinal direction from a rear end to a front end of the fiber optic connector. The fiber optic connector further comprises a ferrule, which is arranged deflectable against the force of a spring in a ferrule holder arranged adjacent to the front end of the tubular base element. Further, a ferrule holder with therein arranged ferrule to terminate the at least one optical fiber.

A fiber optic connector according to the disclosure is predestined for applications in connection with long cables (length >50 meters) or applications in which axial load occurs (e.g. hanging cables). Such situations often occur at Cell Site-, Mining-and Broadcast-Facilities, where cable assemblies are coiled and uncoiled frequently and/or fiber movement is common due to longitudinal environmental stress (e.g. shrinkage and expansion of antenna towers). For connecting the fiber optic connector to e.g. a mating fiber optic connector or a base station, the fiber optic connector typically comprises a plug element.

Especially for outdoor applications, a robust, easy to assemble and reliable fiber optic connector is desired which can withstand harsh environmental influences. Depending on the size and available assembly space, the tubular base element can either be made as a single part or a multipart base element. Good results regarding an assembly friendly and robust design can be achieved when the tubular base element of the fiber optic connector is assembled from a tubular rear base element and a thereto connected tubular front base element as described hereinafter. In the case of a multipart design with a tubular rear base element and a tubular front base element, the rear end of the tubular rear base element is typically at the same time the rear end of the overall tubular base element. Respectively the front end of the tubular front base element is at the same time typically also the front end of the overall tubular base element.

The tubular rear base element typically comprises on its inside a fiber deflection section in form of a receiving space in which the fiber can sufficiently deflect in a lateral direction. In a variation, the tubular rear base element comprises a first opening at its rear end and a second opening at its front end, which first and second opening are configured to allow the at least one optical fiber to extend through the tubular rear base element. The receiving space can have a varying cross section between the first and the second opening, allowing the at least one optical fiber to deflect.

A fast and reliable connection and therefore an efficient assembly can be achieved when the tubular front base element and the tubular rear base element are connected to each other by a snap connection. The shoulders can be designed to form an undercut in longitudinal direction. This undercut can be designed as a circumferential groove, which is in the mounted state formed by the shoulders. The tubular front base element typically comprises at its rear end a recess in which a front section of the tubular rear base element is arranged in a form fit manner. Good results can be achieved when the front end of the tubular rear base element is designed as a collar, which corresponds to a recess of the tubular front base element. It may be arranged in the tubular front base element in a self-locking, e.g. press-fit manner, to avoid ejection of the latter due to the load of the ferrule spring, which is typically in the range of 20 Newton. The tubular front base element and the tubular rear base element are typically interconnected to each other by a snap ring, which is arranged between opposite circumferential shoulders of the tubular front base element and the tubular rear base element. To additionally increase the protection against an unwanted rotation of the tubular rear base element with respect to the tubular front base element, at least one anti-twist element can be arranged at the front end of the tubular rear base element. The anti-twist element typically engages with a recess of the tubular front base element and prevents the rotation of the tubular rear base element with respect to the tubular front base element.

Usually, after the tubular rear base element has been assembled, encompassing e.g. a pre-fabricated cable assembly, a ferrule holder with therein-arranged ferrule and spring can be arranged at the front end of the tubular rear base element. The pre-assembled unit, comprising the tubular rear base element, ferrule holder with ferrule and spring, as well as the connection element can form a pre-fabricated unit. The pre-fabricated unit is typically connected to the tubular front base element by connecting a front section of the tubular rear base element to the tubular front base element, forming the base element.

The front section of the tubular rear base element is typically inserted into a recess at the rear end of the tubular front base element, along with the ferrule holder. After inserting the tubular rear base element with the ferrule holder, the connection element can be adjusted along the longitudinal direction to finalize the free length of the at least one optical fiber inside the base element, before the connection element is fixated to the tubular rear base element. The interconnected tubular rear base element and front base element can encompass the ferrule holder of the fiber optic connector. The ferrule holder typically comprises a ferrule, which is arranged within the ferrule holder deflectable against the force of a spring. The ferrule holder may comprise a shoulder which when inserted from the rear end into the tubular front base element can abut against a shoulder of the tubular rear base element. In the mounted state the shoulder of the ferrule holder can be secured between the shoulder of the tubular rear base element and a groove of the thereto attached tubular front base element.

In a preferred variation, the fiber optic connector comprises a connection element, to which the fibers and the empty tube are firmly connected, preferably by gluing them into the bushing. The connection element is typically arranged at the rear end of the tubular base element, configured to mechanically attach an optical cable to the tubular base element. During assembly the connection element can be arranged with respect to the tubular base element in an adjustable manner along the longitudinal direction. The connection element is thereby configured to adjust the free length of the optical fiber, extending between the connection element and the ferrule. During assembly, the connection element with the thereto attached optical cable is interconnected to the rear end of the tubular base element as described hereinafter. The connection element can be arranged inside the rear end of the tubular base element, e.g. in a bore within the tubular base element in a slidable manner, configured to mechanically attach the optical cable to the tubular rear base element.

The connection element, e.g. in the form of a bushing or a cylindrical sleeve, may comprise a collar for receiving the end section of the optical cable. The collar can be designed such that it can receive the cable jacket and/or the cable braid of the optical cable, while the at least one optical fiber extends through the connection element into the tubular base element. The end section of the optical cable can be attached to the collar by crimping and/or with an adhesive. The connection element can typically be either inserted into the rear end of the tubular base element or slid onto the rear end of the tubular base element, respectively the tubular rear base element in an alternative variation. This allows that the free length of the optical fiber can be adjusted. The connection element and the tubular base element can during assembly be arranged telescopic with respect to each. Typically, a recess is formed between the connection element and the tubular base element, configured to receive in different longitudinal positions an adhesive by an inlet for fixation of the connection element. The connection element can have a through hole for the at least one optical fiber, which through hole can have a smooth inlet and/or smooth outlet. This allows a deflection of the at least one optical fiber at the exit of the at least one optical fiber at the connection element.

The connection element with thereto attached optical cable can be adjusted in longitudinal direction to straighten the fibers in the tubular rear base element and thereby adjust the relevant length of the fiber optic connector to the free fiber length of the at least one optical cable. Usually after assembling the tubular base element, the connection element is secured to fixate the free length of the optical fiber within the base element. Typically, an adhesive like e.g. epoxy resin is injected through an inlet in the form of a through hole arrange in the tubular rear base element. The hole can be arranged adjacent to the rear end of the tubular rear base element and the recess is filled with adhesive until superfluous adhesive exits a vent hole typically arranged in the opposite half shell of the tubular rear base element.

To achieve a mechanically stable attachment even under changing axial loads due to thermal expansions and/or creeping, a recess can be formed by corresponding grooves in the tubular base element and the connection element. In a variation the recess is formed by annular grooves or a thread arranged at the connection element and/or indentations arranged at the rear end of the tubular base element. In the mounted state, the crimp sleeve can attach the connection element to the tubular base element. In case that adhesive is used, the crimp sleeve retains the connection element in its position until the adhesive in the recess has set. This allows to continue the assembly without keeping the base element in a fixture until the adhesive has cured. The crimp sleeve can support/reinforce the connection element and tubular rear base element in case of side load in application.

Additional stability and sealing of the connection can be achieved when an additional crimp sleeve is mounted, encompassing the connection element. The crimp sleeve can be attached to the tubular base element, which in the mounted state encompasses the connection element and is crimped to the rear end of the tubular base element and the connection element. The crimp sleeve can be crimped to the collar of the connection element and thereby additionally securing the optical cable to the connection element by the crimp force.

Due to the crimped-on crimp sleeve the assembly with optionally applied uncured adhesive is instantly fixed so that there is no idle required in the assembly process until the adhesive for the retention of the cable plug has set. This solution avoids squeezing the fiber, which can affect the optical performance. The connection element with thereon mounted crimp sleeve attaches the fibers and the optical cable as such is firmly attached to the connection element by gluing. In this way, the fibers and the empty tube are stopped from being pushed into the fiber optic connector. Depending on the design, the connection element is held crimp sleeve alone, without the need for gluing the connection element to the tubular base element. In addition, the crimp sleeve can further improve the structural integrity of the overall connector. The crimp sleeve can in particular strengthen the rear end of the tubular base element, which can be especially beneficial for the dissipation of bending forces.

The ferrule holder is typically arranged inside of the tubular base element adjacent to the front end. The ferrule together with the spring may be arranged inside of the ferrule holder, which spring extends in longitudinal direction from a shoulder of the tubular base element to the ferrule. When assembling the fiber optic connector.

Independent of the design of the tubular base element (single part or multipart), to prevent a rotation of the ferrule holder with respect to the longitudinal direction, the ferrule holder can comprise a projection, which in the mounted state engages with a recess of the ferrule holder or vice versa. The ferrule is typically designed as a mechanical transfer ferrule. MT ferrules allow passive or active fiber coupling packages. The at least one fiber is typically attached to the ferrule with an fiber optic connector grade thermal cure epoxy and can be polished with a variety of commercially available batch connector polishing machines. In the mounted state, the spring can be arranged adjacent to the front end of the tubular base element and rest against a shoulder of the tubular base element. To avoid rotation of the ferrule holder with respect to the longitudinal direction the ferrule holder can comprise at least one elevation, which interact with a corresponding recess in the tubular base element. In a variation, the elevation can be designed as a tongue which in the mounted state engages with a groove of the tubular base element. In a case of a multipart design of the tubular base element, the groove can extend from the rear end to the front end of the tubular front base element. Depending on the design, the fiber optic connector can be configured to interconnect a number of optical fibers.

In a variation, the fiber optic connector is designed as a Multi-fiber push on connector (MPO connector). MPO connectors are designed to reduce the amount of time required for fusion splicing individual connectors. Combining a number of fibers in one connector, the MPO connector not only greatly reduces the time of connecting fibers, but also saves a lot of space. MPO ferrules allow the preparation of fiber tip protrusion with reduced polishing time and force resulting in superior end-face geometry control. MPO ferrules are typically available from 2, 4, 8, 12, 16, 24, 32 & 48 cores.

The fiber optic connector can comprise a protection sleeve. The protection sleeve is typically assembled by sliding it over the tubular base element from the rear side of the tubular base element. The protection sleeve is typically configured to seal the optical cable, the at least one optical fiber and the tubular base element against environmental influences and in addition protect the tubular base element from bumps or when falling. Good results can be achieved when the protection sleeve is mounted such that it encompasses both the tubular connection element and is attached to the tubular base element by a crimp ring. The crimp ring can be arranged outside of the snap ring. The protection sleeve is typically made form a soft elastic material and at its rear end can merge into a cable kink protection. The protection sleeve can comprise a circumferential collar on the inside at its front end, which in the mounted state engages with an annular recess arranged at the tubular front base element or vice versa.

Good results can be achieved when the tubular base element or the tubular rear base element and/or the tubular front base element consist of two half shells which are interconnected to each other. Preferably the two half shells are interconnected to each other along a parting plane which extends in longitudinal direction. For a positionally accurate mounting the half shells can be assembled to each other via a snap connection and/or with pins and thereto corresponding holes, thereby encompassing the therein arranged free length of the at least one optical fiber. A good compromise between weight and structural integrity can be achieved when the tubular base element or in particular the tubular rear base element comprises ribs, reinforcing the outer shell-surface.

The plug element, which is typically arranged at the front end of the tubular base element can comprise a locking mechanism with a latch element, which automatically latches during connection. The latch element can be configured to interact and engage with locking elements, e.g. in the form of latch lugs or a collar. The latch element is therefore typically designed as an elastically expandable locking ring, which can be arranged concentrically with respect to the longitudinal direction. To achieve a quick-locking connection, the plug element may comprise an actuating element, which comprises a locking sleeve, which is arranged concentrically with respect to the longitudinal direction and displaceable along the longitudinal direction for unlocking the locking ring. In a variation, the tubular base element comprises a circumferential recess, arranged adjacent to the front end, configured to receive a latch element for interconnecting the fiber optic connector to a mating fiber optic connector. When being pulled by an operator, the locking sleeve interacts with the latch element and retracts the latch element. In addition, to seal the connection against environmental influences in the mounted state, a seal can be arranged inside the tubular base element encompassing the ferrule holder, which in a mounted state seals the connection against environmental influences.

A variation for an assembly process for assembling a fiber optic connector body with a multipart tubular base element and at least one optical fiber, carried out as follows:
Mounting the tubular rear base element around the at least one optical fiber, preferably around a pre-fabricated cable assembly fixed at the end to the cable with a connection element and already comprising a spring and ferrule. The connection element can in its forward position be arranged such that its front end is arranged adjacent to or inside the fiber deflection, to allow the spring to be relieved for assembly of the tubular front base element.
Inserting the ferrule along with the tubular rear base element into the tubular front base element.
Adjusting the connection element, arranged preferably telescopic with respect to the tubular rear base element, along the longitudinal direction to keep the free length of the at least one optical fiber inside the tubular rear base element straight.
Inserting the front section of the tubular rear base element into the recess of the tubular front base element, preferably with a press-fit, to avoid ejection due to the load of the spring.
Fixating the tubular rear base element by inserting a snap ring into groove formed by the tubular front base element and the tubular rear base element.
Optionally, injecting an adhesive, e.g. through the inlet into the recess between the tubular rear base element and the connection element until excessive adhesive exits an outlet, preferably arranged opposite to the inlet.
Placing the crimp sleeve on the tubular rear base element and the connection element. Pulling the optical cable to straighten the at least one optical fiber in the tubular rear base element and crimping the crimp sleeve onto the tubular rear base element and the connection element. The crimp sleeve thereby fixates the relative distance of the connection element to the tubular rear base element. In case adhesive is used, the crimp sleeve can retain the connection element in its position until the epoxy adhesive in the tubular rear base element has set.
Optionally, sliding a protection sleeve from the optical cable, placed thereon before the assembly, over the tubular rear base element and the rear end of the tubular front base element. The protection sleeve can seal the optical cable and the base element.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The disclosure will be more fully understood from the detailed description given herein below and the accompanying drawings which should not be considered limiting to the disclosure described in the appended claims.

FIG. 1 shows a variation of the fiber optic connector in a perspective view from the front and above with a partial cut out;

FIG. 2 shows an enlarged detail view of the tubular rear base element and the tubular front base element of the fiber optic connector according to FIG. 1;

FIG. 3 shows the fiber optic connector according to FIG. 1 in a perspective exploded view from the front and above with a partial cut out;

FIG. 4a shows the base element of the fiber optic connector according to FIG. 1;

FIG. 4b shows a sectional view of the base element according to FIG. 4a;

FIG. 5a shows the fiber optic connector according to FIG. 1;

FIG. 5b shows an enlarged detail view of the ferrule holder of the fiber optic connector according to FIG. 5a;

FIG. 6a shows in FIG. 6a the fiber optic connector according to FIG. 1;

FIG. 6b shows an enlarged detail view of the connection element of the fiber optic connector according to FIG. 6a;

FIG. 7a shows the fiber optic connector according to FIG. 1;

FIG. 7b shows an enlarged detail view of the plug element of the fiber optic connector according to FIG. 7a;

FIG. 8a shows the base element of an alternative variation of the fiber optic connector; and

FIG. 8b shows a sectional view of the base element of the alternative variation of the fiber optic connector.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

FIGS. 1 to 3 show a variation of the fiber optic connector 1. The shown fiber optic connector 1 comprises a multipart tubular base element 2 and a thereto interconnected plug element 36 for interconnecting the fiber optic connector 1 to e.g. a mating fiber optic connector 1. The tubular front base element 9 and the tubular rear base element 5 of the shown variation are connected to each other by a snap connection 18 and are in the longitudinal direction x fixated to each other by a snap ring 20, which is arranged between opposite circumferential shoulders 19 of the tubular front base element 9 and the tubular rear base element 5. The shoulders 19 are designed to form an undercut in circumferential direction. The undercut is designed as a circumferential groove, which is in the mounted state formed by the shoulders 19. The shown snap ring 20 is arranged within the circumferential groove and thereby mechanically interconnects the tubular front base element 9 and the tubular rear base element 5 to each other in longitudinal direction x. The snap ring 20 of the shown variation is inserted into the circumferential groove after interconnecting the tubular rear base element 5 to the tubular front base element 9. To achieve a torsional stiff design, especially regarding bending forces along the longitudinal axis, the shown recess 12 at the rear end 10 of the tubular front base element 9 extends from the rear end of the tubular front base element 9 along the longitudinal axis x towards the front end of 11 the tubular front base element 9.

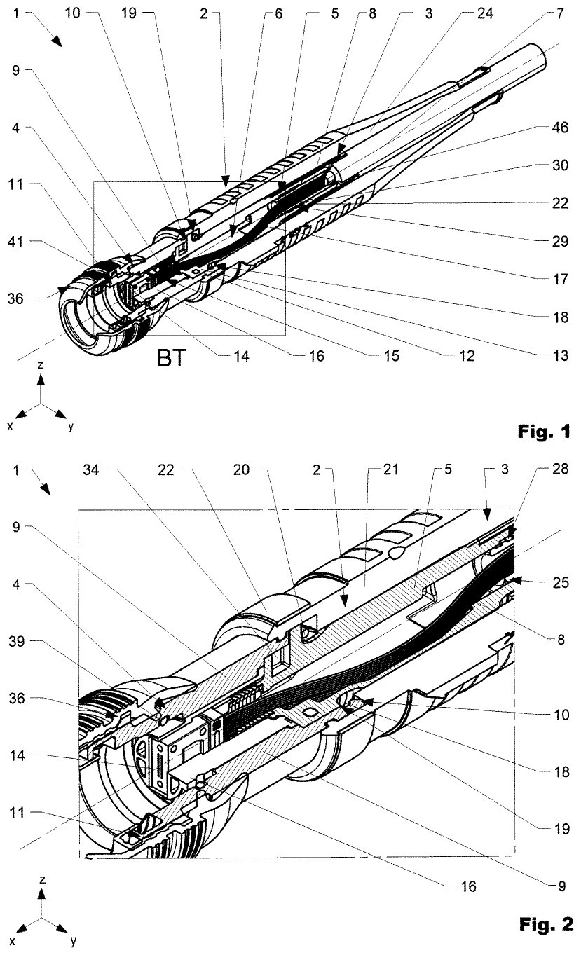

FIG. 2 shows a tubular rear base element 5, which forms a fiber deflection section 6. In the shown variation the tubular rear base element 5 comprises a first opening 43 arranged at its rear end and a second opening 44 arranged at its front end, which first 43 and second 44 opening are configured to allow the at least one optical fiber 8 to be passed through the tubular rear base element 5 along the longitudinal axis x. The tubular rear base element 5 can form a receiving space with a varying cross section for the at least one deflected optical fiber 8 between the first 43 and the second 44 opening.

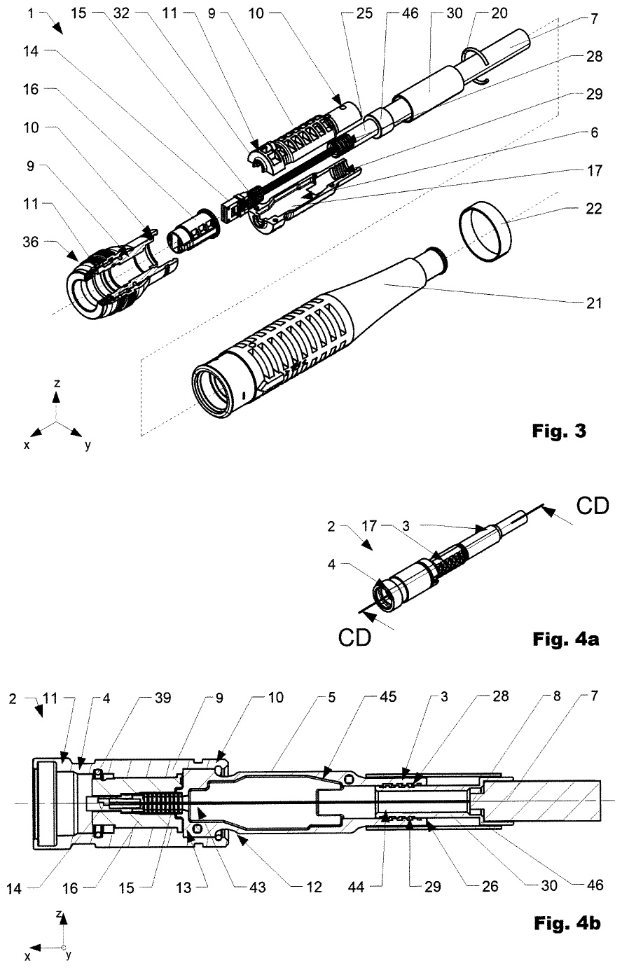

FIG. 3 shows the base element 2 of the shown fiber optic connector 1, being assembled from a tubular rear base element 5 and a thereto-connected tubular front base element 9. The tubular rear base element 5 of the shown variation is assembled around the free length of the at least one optical fiber 8. The shown tubular rear base element 5 consists of two half shells 17 which are interconnected to each other. The two half shells 17 are interconnected to each other along a parting plane which extends in longitudinal direction x. For a positionally accurate mounting the shown half shells 17 are assembled to each other via a snap connection or with pins, thereby encompassing the therein arranged at least one optical fiber 8. The shown tubular front base element 9 has a connection interface at its front end 11 for attaching a plug element 36 to the tubular front base element 9 and a connection interface at its rear end 10 for attaching the tubular rear base element 5 to the tubular front base element 9.

The shown tubular front base element 9 is typically configured to interconnect the plug element 36 to the tubular rear base element 5 and house a ferrule holder 16, which is arranged inside of the tubular front base element 9 and in front of the tubular rear base element 5. The shown ferrule holder 16 is arranged between the rear end 10 and the front end 11 of the tubular front base element 9. In the shown variation, the tubular front base element 9 comprises an annular groove, configured to receive a seal 39. The annular groove and therein-arranged seal 39 can be arranged encompassing the ferrule holder 16. The front end of the shown variation of the tubular rear base element 5 is designed as a cylindrical collar, which corresponded to the recess 12 and is press-fitted into the tubular front base element 9 to avoid ejection of the latter due to the load of the spring 15, which is typically in the range of 20N. To additionally increase the protection against an unwanted rotation of the tubular rear base element 5 with respect to the tubular front base element 9, anti-twist element 34 are arranged at the front end of the tubular rear base element 5.

The shown anti-twist elements 34 engage with a recess of the tubular front base element 9 and prevent the rotation of the tubular rear base element 5 with respect to the tubular front base element 9. The shown variation of the fiber optic connector 1 comprises an anti-kink boot in form of a protection sleeve 21. The shown protection sleeve 21 is assembled by sliding it over the base element 2 from the rear end of the tubular rear base element 5. The protection sleeve 21 is configured to seal the optical cable 7 and the base element 2 against environmental influences and in addition to protect the base element 2 from bumps or when falling. The shown protection sleeve 21 is mounted in manner such that the tubular front base element 9 and the tubular rear base element 5 are partially encompassed by the protection sleeve 21. Good results can be achieved when the protection sleeve 21 is mounted as shown, such that it encompasses both the connection element 25 and the tubular rear base element 5 and is attached to the tubular front base element 9 by a crimp ring. The shown protection sleeve 21 is made from a soft elastic material and at its rear end merges into a cable kink protection. The protection sleeve 21 of the shown variation comprises a circumferential collar on the inside at its front end, which in the mounted state engages with an annular recess arranged at the tubular front base element 9.

FIG. 4 shows the base element 2 of the fiber optic connector 1 in FIG. 4a and a sectional view of the base element 2 in FIG. 4b. The shown variation of the base element 2 is designed as a multipart base element 2, which is configured to be interconnected to a plug element 36 for interconnecting the fiber optic connector 1 to e.g. a mating fiber optic connector. The shown base element 2 of the fiber optic connector 1 is assembled from a tubular rear base element 5 extending in the longitudinal direction x from a rear end to a front end and a thereto connected tubular front base element 9. As can be obtained best from FIG. 6b, the shown tubular rear base element 5 forms a fiber deflection section 6. The shown variation of the tubular rear base element 5 comprises a first opening 43 at its rear end and a second opening 44 at its front end, which first 43 and second opening 44 are configured to allow the at least one optical fiber 8 to extend through the tubular rear base element 5.

The tubular rear base element 5 forms a receiving space with a varying cross section for allowing the at least one optical fiber 8 to deflect between the first 43 and the second 44 opening. The cross section of the receiving space typically has a larger diameter than the diameter of the first 43 and/or the second opening 44. Good results regarding a smooth transition between the first 43 and/or the second 44 opening and the receiving space can be achieved, when the diameter of the first 43 and/or the second opening 44 gradually widens up into the diameter of the receiving space. For a smooth transition a lead in surface 45 can be arranged between the first opening 43 and the receiving space and/or the second opening 44 and the receiving space. The shown variation comprises a deflection section with several zones, a first zone arranged adjacent to the front end of the tubular rear base element 5 and/or a second zone arranged adjacent to the rear end of the tubular rear base element 5 and a third zone arranged between the first and the second zone. The diameter of the shown third zone is larger than the diameter of the first and/or second zone.

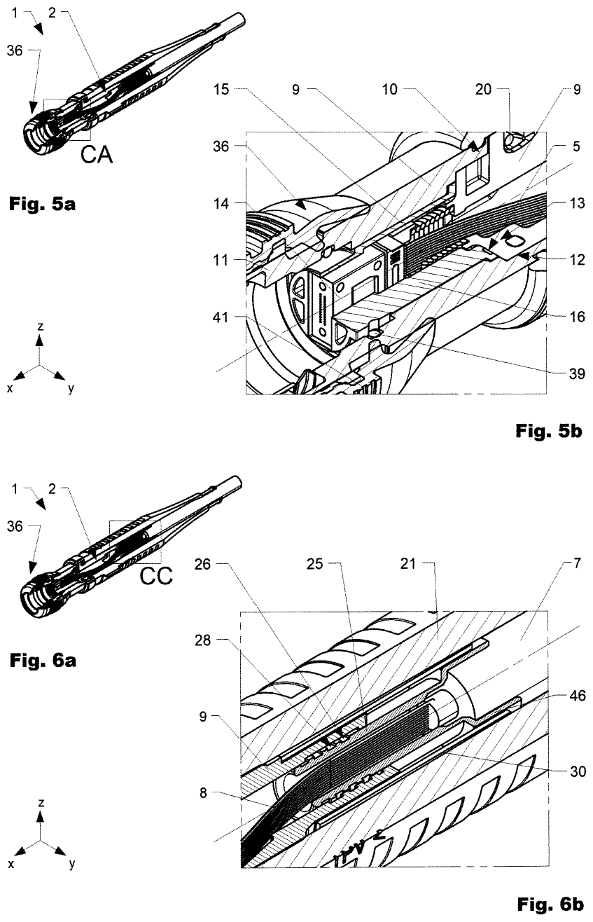

FIG. 5 shows the fiber optic connector 1 in FIG. 5a and in FIG. 5b an enlarged detail view of the ferrule holder 16 of the fiber optic connector 1. The fiber optic connector comprises a ferrule 14, which is typically assembled together with the tubular rear base element 5. The ferrule 14 can be arranged within a ferrule holder 16, which can be arranged inside the tubular front base element 9. The ferrule 14 is typically arranged deflectable against the force of a spring in a ferrule holder 16 arranged inside of the tubular front base element 9 in front of the tubular rear base element 5. The ferrule 14 together with the spring may be arranged inside of the ferrule holder 16, which spring extends in longitudinal direction from a shoulder of the tubular rear base element 5 to the ferrule 14. When assembling the fiber optic connector, the ferrule holder 16 is typically inserted into the tubular front base element 9 from the rear end and in the mounted state abuts against a shoulder of the tubular rear base element 5.

To prevent a rotation of the ferrule holder 16 with respect to the longitudinal direction, the ferrule holder 16 can comprise a projection which in the mounted state engages with a recess of the ferrule holder 16. The ferrule 14 is typically designed as a mechanical transfer (MT) ferrule 14. MT ferrules 14 allows passive or active fiber coupling packages. The at least one fiber is typically attached to the ferrule 14 with a fiber optic connector grade thermal cure epoxy and can be polished with a variety of commercially available batch connector polishing machines. The ferrule holder 16 may comprise a shoulder which when inserted from the rear end into the tubular front base element 9 can abut against a shoulder of the tubular rear base element 5. In the mounted state the shoulder of the ferrule holder 16 can be secured between the shoulder of the tubular rear base element 5 and a groove of the thereto attached tubular front base element 9. In the mounted state the spring can be arranged adjacent to the front end of the tubular rear base element 5 and the ferrule 14. Depending on the design the fiber optic connector can be configured to interconnect a number of optical fibers 8. The ferrule 14 may therefore comprise a number of plug-in places arranged in a line and configured to receive a number of optical fibers 8. In a variation the fiber optic connector is designed as a Multi-fiber push on connector (MPO connector).

FIG. 6 shows the fiber optic connector 1 in FIG. 6a and in FIG. 6b an enlarged detail view of the connection element 25 of the fiber optic connector 1. To be able to provide a pre-assembled base element 2, consisting of the tubular front base element 9, tubular rear base element 5 and ferrule holder 16 with therein arranged ferrule 14 with a predefined free length of the at least one optical fiber 8, the optical cable 7 needs to be attached to the base element 2. In the shown variation the free fiber length of the at least one optical fiber 8 between the ferrule 14 and the end of the optical cable 7, where the at least one optical fiber 8 exits the optical cable 7, is adjusted by the connection element 25 which is arranged adjustable along the longitudinal direction x.

The shown connection element 25 is arranged at the rear end 10 of the tubular rear base element 5 and configured to mechanically attach the optical cable 7 to the tubular rear base element 5. The shown connection element 25 is designed as a cylindrical sleeve, which comprises a collar for receiving an end section of the optical cable 7. The end section of the optical cable 7 can be attached to the collar by crimping and/or with an adhesive. The cylindrical sleeve, with thereto-attached end section of the optical cable 7 can be either inserted into the rear end 10 of the tubular rear base element 5 or slid onto the rear end 10 of the tubular rear base element 5. The free length of the optical fiber 8 can be adjusted if the connection element 25 and the tubular rear base element 5 are during assembly arranged telescopic with respect to each and form a recess 26 between them configured to receive in different longitudinal positions an adhesive by an inlet 27. After the tubular rear base element 5 has been assembled, encompassing the pre-fabricated optical cable 7 assembly, the connection element is arranged at the rear end of the tubular rear base element 5 and the ferrule holder 16 with therein arranged ferrule 14 and spring 15 are arranged at the front end 11 of the tubular rear base element 5.

The tubular rear base element 5 is typically attached to the tubular front base element 3, forming the base element 2. The tubular rear base element 9 is thereby inserted into the tubular front base element 9 along with the ferrule holder 16. After inserting the tubular rear base element 5 with the ferrule holder 16, the connection element 25 is adjusted along the longitudinal direction x to adjust the free length of the at least one optical fiber 8 inside the tubular rear base element 5. In the shown variation a crimp sleeve 30 is used as attachment means, fixating the connection element 25 with respect to the longitudinal direction x. During the assembly of the fiber optic connector 1, the connection element 25 is moved into the rear end of the tubular rear base element 5 before it is after the assembly of the ferrule holder 16 and the tubular front base element 9 pulled back to define the desired free length of the at least one optical fiber 8 and fix it in the final position. By this the free fiber length of the at least one optical fiber 7, which is critical to system function, can easily be controlled during the assembly process. Typically, an adhesive like epoxy resin is injected through an inlet 27 in form of a through hole arrange in the tubular rear base element 5. The hole can be arranged adjacent to the rear end of the tubular rear base element 5 and the recess 26 is typically filled with adhesive until superfluous adhesive exits a vent hole typically arranged in the opposite half shell of the tubular rear base element 5. Additional stability and sealing of the crimp connection can be achieved when an additional crimp sleeve 30 is mounted, encompassing the connection element 25.

The crimp sleeve 30 can be crimped to the collar 46 of the connection element 25 and thereby additionally securing the optical cable 7 to the connection element 25 by the crimp force. In addition, the crimp sleeve 30 can be crimped to the rear end of the tubular rear base element 5. Due to the crimped-on crimp sleeve 30 the assembly with optionally applied uncured adhesive is instantly fixed so that there is no idle required in the assembly process until the adhesive for the retention of the connection element 25 has set. This solution avoids squeezing the at least one optical fiber 8 which can affect the optical performance. The connection element 25 with thereon mounted crimp sleeve 30 attaches the optical cable 7 firmly to the connection element 25 by gluing. In this way the optical cable 7 and thereby the at least one optical fiber 8 are stopped from being pushed into the base element 2. To achieve a mechanically stable attachment even under changing axial loads due to thermal expansions and/or creeping, the recess 26 can be formed by corresponding grooves 28 in the tubular rear base element 5 and the connection element 25. In a variation, the recess 26 is formed by annular grooves or a thread 28 arranged at the connection element 25 and/or indentations 29 arranged at the rear end of the tubular rear base element 5. The crimp sleeve 30 fixates the position of the connection element 25 to the tubular rear base element 5. In case adhesive is used, the crimp sleeve 30 retains the connection element 25 in its position until the epoxy adhesive in the tubular rear base element 5 has set.

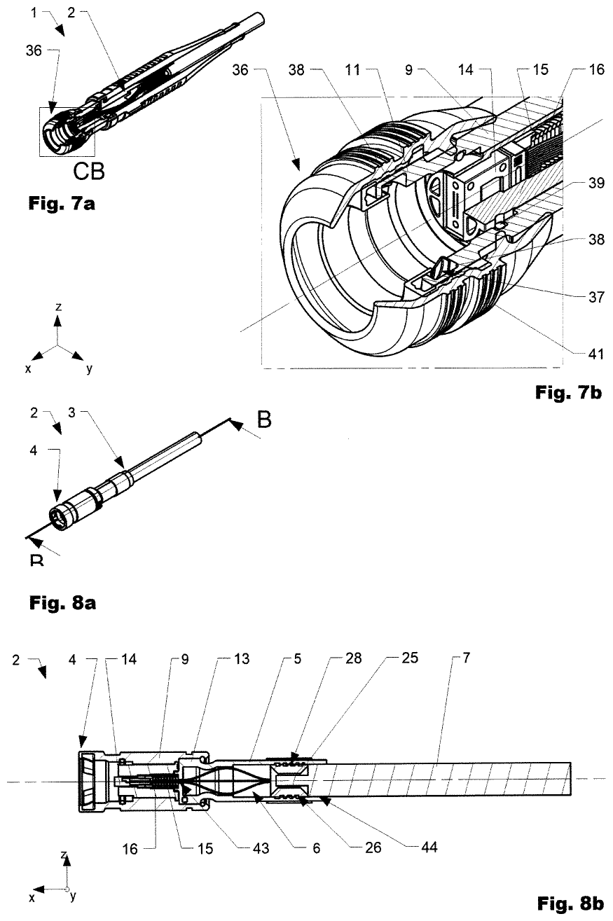

FIG. 7 shows the fiber optic connector 1 in FIG. 7a and in FIG. 7b an enlarged detail view of the plug element 36. For connecting the fiber optic connector 1 to e.g. a mating optic connector or a base station, the shown fiber optic connector 1 comprises a plug element 36. The shown plug element 36 is arranged at the front end 11 of the tubular front base element 9 and comprises a locking mechanism with a latch element 38, which automatically latches during connection. The shown latch element 38 is configured to interact and engage with the locking ring 40. The latch element 38 of the shown variation is designed as an elastically expandable locking ring 40, which is arranged concentrically with respect to the longitudinal direction x. To achieve a quick-locking connection, the shown plug element 36 comprises an actuating element 41 comprising a locking sleeve 42 which is arranged concentrically with respect to the longitudinal direction x and displaceable along the longitudinal direction x for unlocking the locking ring 40. In the shown variation, the tubular front base element 9 comprises a circumferential recess, arranged adjacent to the front end 11, configured to receive the latch element 38 for interconnecting the fiber optic connector 1 to a mating fiber optic connector. When being pulled by an operator, the locking sleeve 42 interacts with the latch element 38 and retracts the latch element 38. In addition, to seal the connection against environmental influences in the mounted state, a seal 39 can be arranged inside the tubular front base element 9 encompassing the ferrule holder 16, which in a mounted state seals the connection against environmental influences.

FIG. 8 shows an alternative variation of the base element 2 of the fiber optic connector 1 in FIG. 8a and a sectional view of the base element 2 in FIG. 8b. The shown variation of the base element 2 is also designed as a multipart base element 2, with a tubular rear base element 5 and a tubular front base element 9, which base element 2 is configured to be interconnected to a plug element 36 for interconnecting the fiber optic connector 1 to e.g. a mating fiber optic connector. In the shown variation the free fiber length of the at least one optical fiber 8 between the ferrule 14 and the end of the optical cable 7, where the at least one optical fiber 8 exits the optical cable 7, is adjusted by the connection element 25. The shown connection element 25 is designed as a sleeve, which is arranged within the tubular rear base element 5. The shown connection element 25 is arranged adjustable along the longitudinal direction x. In comparison to the first variation of the base element 2, as shown in FIG. 4, the connection element 25 is arranged within the tubular base element 2 and during assembly arranged telescopic with respect to the longitudinal direction x. The shown connection element 25 is arranged in a bore within the tubular base element 2 in a slidable manner.

Rather, the words used in the specification are words of description rather than limitation, and it is understood that various changes may be made without departing from the Spirit and scope of the disclosure.

1. A fiber optic connector comprising:
a. a tubular base element, which extends in a longitudinal direction from a rear end to a front end and comprises
i. a tubular rear base element which comprises on the inside a fiber deflection section configured to provide deflection room for at least one laterally deflected optical fiber extending in a mounted position of the fiber optic connector across the tubular rear base element, and
ii. a tubular front base element which comprises at its rear end a recess in which a front section of the tubular rear base element is arranged in a form fit manner;
b. a ferrule arranged deflectable against the a force of a spring in a ferrule holder arranged adjacent to the front end of the tubular base element, inside of the tubular front base element and in front of the tubular rear base element.

2. The fiber optic connector according to claim 1, wherein the tubular rear base element comprises two half shells interconnected to each other along a parting plane extending in the longitudinal direction.

3. The fiber optic connector according to claim 1, wherein the tubular front base element and the tubular rear base element are interconnected to each other by press-fit connection.

4. The fiber optic connector to claim 1, wherein the tubular front base element and the tubular rear base element are interconnected to each other by a snap ring, arranged between opposite circumferential shoulders of the tubular front base element and the tubular rear base element, forming an undercut in the longitudinal direction.

5. The fiber optic connector according to claim 1, wherein the ferrule holder comprises a shoulder which when inserted from the rear end into the tubular front base element abuts against a shoulder of the tubular rear base element.

6. The fiber optic connector according to claim 1, wherein the spring is arranged inside of the ferrule holder extending in the longitudinal direction from the shoulder of the tubular rear base element to the ferrule.

7. The fiber optic connector according to claim 1, wherein at least one anti-twist element is arranged at the front end of the tubular rear base element which engages with a recess of the tubular front base element and prevents the rotation of the tubular rear base element with respect to the tubular front base element.

8. The fiber optic connector according to claim 1, wherein the tubular front base element and the tubular rear base element are at least partially encompassed by a protection sleeve.

9. The fiber optic connector according to claim 8, wherein the protection sleeve is attached to the tubular front base element by a crimp ring which is arranged outside of the snap ring.

10. A fiber optic connector comprising:
a. a tubular base element which extends in a longitudinal direction from a rear end to a front end, and comprises a fiber deflection section configured to provide deflection room for at least one laterally deflected optical fiber extending in a mounted position of the fiber optic connector at least partially across the tubular base element;
b. a connection element which is
i. arranged at the rear end of the tubular base element configured to mechanically attach an optical cable to the tubular base element and
ii. arranged with respect to the tubular base element in an adjustable manner along the longitudinal direction to adjust the free length of the optical fiber extending between the connection element and the ferrule at least during assembly before fixation;
c. a ferrule arranged deflectable against the force of a spring in a ferrule holder arranged adjacent to the front end of the tubular base element

11. The fiber optic connector according to claim 10, wherein the connection element and the tubular base element are during assembly arranged telescopically with respect to each and form a recess between them, configured to receive in different longitudinal positions an adhesive by an inlet

12. The fiber optic connector according to claim 11, wherein the recess is formed by annular grooves or a thread arranged at the connection element and/or indentations arranged at the rear end of the tubular base element.

13. The fiber optic connector according to claim 11, wherein the connection element is arranged in a bore within the tubular base element in a slidable manner.

14. The fiber optic connector according to claim 10, wherein a crimp sleeve is attached to the rear end of the tubular base element, which crimp sleeve encompasses the connection element and is crimped to the rear end of the tubular base element.

15. The fiber optic connector according to claim 10, wherein a plug element is arranged at the front end of the tubular base element which plug element comprises a locking mechanism with a latch element which automatically latches during connection.

16. The fiber optic connector according to claim 10, wherein a seal is arranged inside the tubular base element encompassing the ferrule holder which in a mounted state seals the connection against environmental influences.
